(19) United States
(12) Patent Application Publication
(10) Pub. No.: US 2017/0005312 A1
(43) Pub. Date: Jan. 5, 2017

(54) Lithium-Sulfur Secondary Battery

(71) Applicant: ULVAC, INC., Kanagawa (JP)

(72) Inventors: Yoshiaki Fukuda, Kanagawa (JP); Tatsuhiro Nozue, Kanagawa (JP); Naoki Tsukahara, Kanagawa (JP); Hirohiko Murakami, Kanagawa (JP)

(73) Assignee: ULVAC, INC., Kanagawa (JP)

(21) Appl. No.: 15/101,526

(22) PCT Filed: Oct. 15, 2014
(86) PCT No.: PCT/JP2014/005237

§ 371 Date: Jun. 3, 2016

(30) Foreign Application Priority Data
Dec. 18, 2013 (JP) 2013-261070

(51) Int. Cl. H01M 2/16; H01M 10/0525; H01M 10/0567; H01M 4/38; H01M 4/587; H01M 4/36

(52) U.S. Cl. CPC H01M 2/1653; H01M 4/587; H01M 4/366; H01M 10/0567; H01M 4/38; H01M 10/0525

(57) ABSTRACT

Provided is a lithium-sulfur secondary battery capable of suppressing diffusion of a polysulfide eluded into an electrolytic solution into a negative electrode and capable of suppressing lowering of a charge-discharge capacity. In the lithium-sulfur secondary battery of this invention, including a positive electrode P containing a positive electrode active material containing sulfur, a negative electrode N containing a negative electrode active material containing lithium, and a separator S disposed between the positive electrode and the negative electrode to hold an electrolytic solution L, a polymer nonwoven fabric F containing a sulfonic group is disposed at least one of between the separator and the positive electrode and between the separator and the negative electrode.

### TECHNICAL FIELD

The present invention relates to a lithium-sulfur secondary battery.

### BACKGROUND ART

Since a lithium secondary battery has a high energy density, an application range thereof is not limited to a handheld equipment such as a mobile phone or a personal computer, but is expanded to a hybrid automobile, an electric automobile, an electric power storage system, and the like. As one of such lithium-sulfur secondary batteries, attention has recently been paid to a lithium-sulfur secondary battery whose charging and discharging is performed through a reaction between lithium and sulfur. As a lithium-sulfur secondary battery there is known, in Patent Document 1, one comprising a positive electrode including a positive electrode active material containing sulfur, a negative electrode including a negative electrode active material containing lithium, and a separator disposed between the positive electrode and the negative electrode to hold an electrolytic solution.

On the other hand, in order to increase the amount of sulfur to contribute to a battery reaction, there is known one, e.g., in Patent Document 2, in which a surface of a collector of the positive electrode has a plurality of carbon nanotubes that are oriented in a direction perpendicular to the surface, and in which a surface of each of the carbon nanotubes is covered with sulfur.

Here, in a positive electrode of a lithium-sulfur secondary battery, a charge-discharge reaction proceeds by repetition of a process in which sulfur (S₈) reacts with lithium through multiple stages to obtain Li₂S finally and a process in which Li₂S returns to S₈. A reaction product called a polysulfide (Li₂Sₓ: x=2 to 8) is generated during the charge-discharge reaction. Li₂S₆ and Li₂S₄ are very easily eluted into an electrolytic solution. In the above-mentioned Patent Document 1 above, the separator is constituted by a polymer nonwoven fabric or a porous film made of resin. According to this arrangement, however, a polysulfide eluted into the electrolytic solution passes through such a separator and is diffused into a negative electrode. The polysulfide diffused into the negative electrode side does not contribute to the charge-discharge reaction, and the amount of sulfur in the positive electrode is decreased. Therefore, a charge-discharge capacity is lowered. If the polysulfide reacts with lithium in the negative electrode, a charge reaction is not accelerated (a so-called redox-shuttle phenomenon occurs), and a charge-discharge efficiency is lowered.

### PRIOR ART DOCUMENTS

### Patent Documents

Patent Document 1: JP 2013-114920 A Patent Document 2: WO 2012/070184 A

### SUMMARY

### Problems to be Solved by the Invention

In view of the above points, an object of this invention is to provide a lithium-sulfur secondary battery capable of suppressing diffusion of a polysulfide that is held in elution in an electrolytic solution into a negative electrode and capable of suppressing lowering of a charge-discharge capacity.

### Means for Solving the Problems

In order to solve the above problems, a lithium-sulfur secondary battery of this invention, including a positive electrode containing a positive electrode active material containing sulfur, a negative electrode containing a negative electrode active material containing lithium, and a separator disposed between the positive electrode and the negative electrode to hold an electrolyte, is characterized by disposing at least one of between the separator and the positive electrode and between the separator and the negative electrode a polymer nonwoven fabric containing a sulfonic group. The separator and the polymer nonwoven fabric containing a sulfonic group may be in contact with each other or may be apart from each other by a predetermined distance. The polymer nonwoven fabric is made of polypropylene or polyethylene.

Here, the separator allows a polysulfide to pass therethrough. Therefore, by elution of the polysulfide generated in the positive electrode into the electrolytic solution, the polysulfide is diffused into the negative electrode side through the separator, and reduction in the amount of sulfur in the positive electrode lowers the charge-discharge capacity. Therefore, this inventions made intensive studies, and have found that a polymer nonwoven fabric containing a sulfonic group allows a lithium ion to pass therethrough and suppresses passing of a polysulfide. In this invention, this polymer nonwoven fabric containing a sulfonic group is disposed at least on a positive electrode side and on a negative electrode side. Therefore, diffusion of a polysulfide, that is eluted into an electrolytic solution, into the negative electrode can be suppressed, and lowering of a charge-discharge capacity can be suppressed.

This invention shall preferably be such that a positive electrode includes a collector and a plurality of carbon nanotubes oriented on a surface of the collector in a direction perpendicular to the surface, and that this invention is applied to a case in which a surface of each of the carbon nanotubes is covered with sulfur. In this case, the amount of sulfur is larger, and a polysulfide is eluted into an electrolytic solution more easily than a positive electrode in which sulfur is applied to a surface of a collector. However, by application of this invention, diffusion of the polysulfide into the negative electrode side can be suppressed effectively.

### BRIEF DESCRIPTION OF THE DRAWINGS

FIG. 1 is a schematic cross sectional view illustrating a structure of a lithium-sulfur secondary battery according to an embodiment of this invention.

FIG. 2 is an enlarged schematic cross sectional view illustrating a positive electrode in FIG. 1.

FIG. 3 is a graph indicating an experimental result (cycle characteristic of discharge capacity retention rate) for confirming an effect of this invention.

### MODES FOR CARRYING OUT THE INVENTION

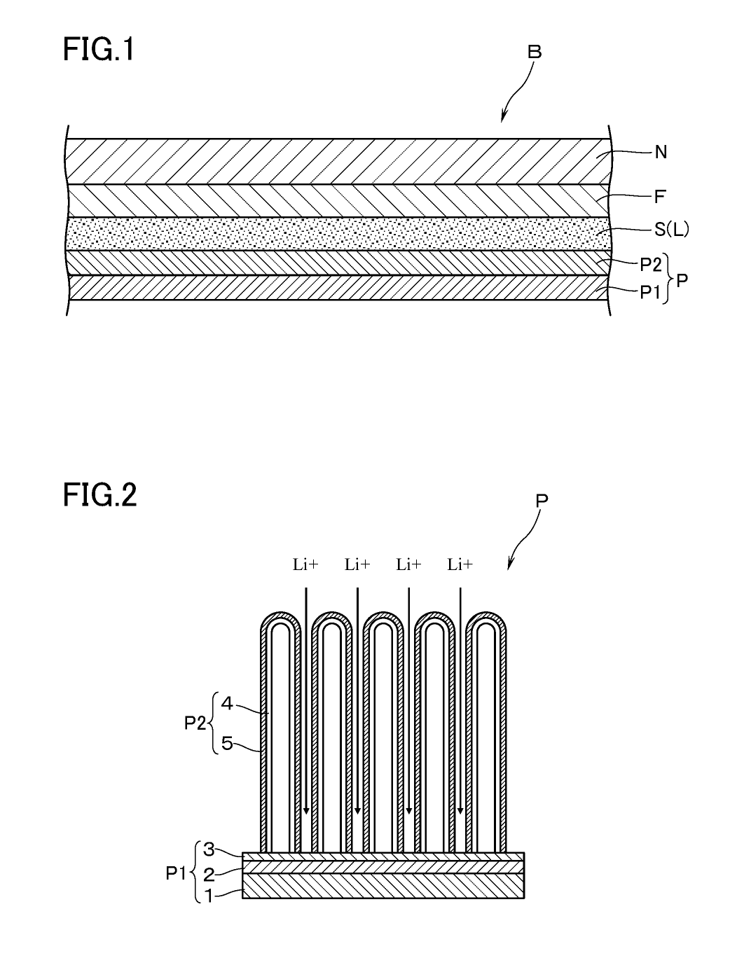

In FIG. 1, the reference mark B represents a lithium-sulfur secondary battery. The lithium-sulfur secondary battery B includes a positive electrode P containing a positive electrode active material containing sulfur, a negative electrode N containing a negative electrode active material containing lithium, and a separator S disposed between the positive electrode P and the negative electrode N to hold an electrolytic solution L.

With reference also to FIG. 2, the positive electrode P includes a positive electrode collector P1 and a positive electrode active material layer P2 formed on a surface of the positive electrode collector P1. The positive electrode collector P1 includes, for example, a substrate 1, an underlying film (also referred to as “a barrier film”) 2 formed on a surface of the substrate 1 and having a film thickness of 5 to 50 nm, and a catalyst layer 3 formed on the underlying film 2 and having a film thickness of 0.5 to 5 nm. A metal foil or a metal mesh made of Ni, Cu, or Pt, for example, can be used as the substrate 1. The underlying film 2 is used for improving adhesion between the substrate 1 and carbon nanotubes 4 described below, and is formed of a metal selected from Al, Ti, V, Ta, Mo, and W or a nitride of the metal. The catalyst layer 3 is formed of a metal selected from Ni, Fe, and Co. The positive electrode active material layer P2 is constituted by a multiplicity of carbon nanotubes 4 grown on a surface of the positive electrode collector P1 so as to be oriented in a direction perpendicular to the said surface, and sulfur 5 covering the entire surface of each of the carbon nanotubes 4. There is a predetermined gap between the respectively adjacent carbon nanotubes 4 covered with the sulfur 5, and the electrolytic solution L described below flows into this gap.

Here, in consideration of a battery characteristic, each of the carbon nanotubes 4 advantageously has a high aspect ratio of a length of 100 to 1000 μm and a diameter of 5 to 50 nm, and it is preferable to grow the carbon nanotubes 4 at a density per unit area of 1×10¹⁰ to 1×10¹² tubes/cm². The sulfur 5 covering the entire surface of each of the carbon nanotubes 4 preferably has a thickness of 1 to 3 nm, for example.

The positive electrode P can be formed by the following method. That is, the positive electrode collector P1 is obtained by forming an Al film as the underlying film 2 and a Ni film as the catalyst layer 3 sequentially on a surface of a Ni foil as the substrate 1. As the method of forming the underlying film 2 and the catalyst layer 3, there can be used, for example, a well-known electron beam vapor deposition method, sputtering method, or clipping method using a solution of a compound containing a catalyst metal. Therefore, detailed description thereof is omitted here. The resulting positive electrode collector P1 is mounted in a processing chamber of a known CVD apparatus, a mixed gas containing a raw material gas and a diluent gas is supplied into the processing chamber at an operation pressure of 100 Pa to an atmospheric pressure, and the positive electrode collector P1 is heated to a temperature of 600 to 800° C. The carbon nanotubes 4 are thereby grown on a surface of the collector P1 so as to be oriented in a direction perpendicular to the said surface. As a CVD method for growing the carbon nanotubes 4, a thermal CVD method, a plasma CVD method, or a hot filament CVD method can be used. For example, a hydrocarbon such as methane, ethylene or acetylene, or an alcohol such as methanol or ethanol can be used as the raw material gas, and nitrogen, argon, or hydrogen can be used as the diluent gas. The flow rates of the raw material gas and the diluent gas can be set appropriately depending on the capacity of a processing chamber. For example, the flow rate of the raw material gas can be set within a range of 10 to 500 sccm, and the flow rate of the diluent gas can be set within a range of 100 to 5000 sccm. Granular sulfur having a particle diameter of 1 to 100 μm is sprayed from above over an entire area in which the carbon nanotubes 4 have been grown. The positive electrode collector P1 is mounted in a tubular furnace, and is heated to a temperature of 120 to 180° C. equal to or higher than the melting point of sulfur (113° C.) to melt the sulfur. When sulfur is heated in the air, the melted sulfur reacts with water in the air to generate sulfur dioxide. Therefore, it is preferable to heat sulfur in an inert gas atmosphere such as Ar, or He, or in vacuo. The melted sulfur flows into a gap between the respectively adjacent carbon nanotubes 4, and the entire surface of each of the carbon nanotubes 4 is covered with the sulfur 5 with a gap between the adjacent carbon nanotubes 4 (refer to FIG. 2). At this time, the weight of sulfur placed as described above can be set according to the density of the carbon nanotubes 4. For example, in a case where the growing density of the carbon nanotubes 4 is 1×10¹⁰ to 1×10¹² tubes/cm², the weight of sulfur is preferably set to a value 0.7 to 3 times the weight of the carbon nanotubes 4. In the positive electrode P formed in this way, the weight of the sulfur 5 (impregnation amount) per unit area of the carbon nanotubes 4 is 2.0 mg/cm² or more.

Examples of the negative electrode N include a Li simple substance, an alloy of Li and Al or In, and Si, SiO, Sn, SnO₂, and hard carbon doped with lithium ions.

The separator S is formed of a porous film or a nonwoven fabric made of a resin such as polyethylene or polypropylene, and can transmit a lithium ion (Li+) between the positive electrode P and the negative electrode N via the electrolytic solution L.

Here, in the positive electrode P, a polysulfide is generated during a reaction between sulfur and lithium through multiple steps. The polysulfide (particularly, Li₂S₄ or Li₂S₆) is eluted into the electrolytic solution L easily. The separator S allows the polysulfide to pass therethrough. Therefore, the polysulfide eluted into the electrolytic solution L passes through the separator S, and is diffused into the negative electrode side. Reduction in the amount of sulfur in the positive electrode gives rise to lowering of the charge-discharge capacity. Therefore, how to suppress the diffusion of the polysulfide into the negative electrode side is important.

Therefore, the inventors of this invention made intensive studies, and have found that a polymer nonwoven fabric containing a sulfonic group allows a lithium ion to pass therethrough and suppresses passing of a polysulfide. Therefore, as illustrated in FIG. 1, a polymer nonwoven fabric F containing a sulfonic group is disposed between the separator S and the negative electrode N. The polymer nonwoven fabric F made of polypropylene or polyethylene can be used. By employing such a structure, the polysulfide eluted into the electrolytic solution L hardly passes through the polymer nonwoven fabric F. Therefore, diffusion of the polysulfide into the negative electrode side can be suppressed, and lowering of the charge-discharge capacity can be suppressed.

The electrolytic solution L contains an electrolyte and a solvent for dissolving the electrolyte. Examples of the electrolyte include well-known lithium bis(trifluoromethanesulfonyl)imide (hereinafter, referred to as “LiTFSI”), LiPF₆, and LiBF₄. As the solvent, a well-known solvent can be used, and for example, at least one selected from ethers such as tetrahydrofuran, glyme, diglyme, triglyme, tetraglyme, diethoxyethane (DEE), and dimethoxyethane (DME) can be used. In order to stabilize a discharge curve, it is preferable to mix dioxolane (DOL) to the at least one selected as above. For example, when a mixed liquid of diethoxy ethane and dioxolane is used as a solvent, the mixing ratio between diethoxyethane and dioxolane can be set to 9:1. In order to form a coating film, on a surface of the negative electrode, allowing a lithium ion to pass therethrough and suppressing passing of a polysulfide, lithium nitrate may be added to the electrolytic solution L.

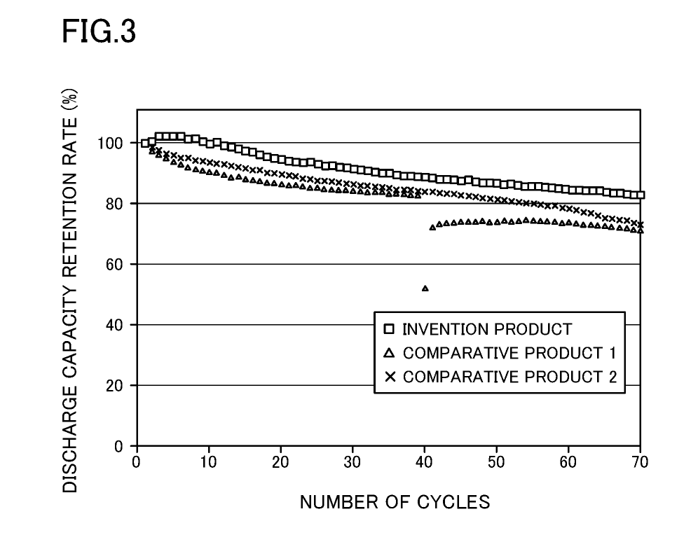

Next, the following experiment was performed in order to confirm an effect of this invention. In the present experiment, first, the positive electrode P was manufactured as follows. That is, a Ni foil having a diameter of 14 mmφ and a thickness of 0.020 mm was used as the substrate 1. An Al film having a thickness of 15 nm as the underlying film 2 was formed on the Ni foil 1 by an electron beam evaporation method, and an Fe film having a thickness of 5 nm as the catalyst layer 3 was formed on the Al film 2 by an electron beam evaporation method to obtain the positive electrode collector P1. The resulting positive electrode collector P1 was mounted in a processing chamber of a thermal CVD apparatus. Then, while acetylene at 200 sccm and nitrogen at 1000 sccm were supplied into the processing chamber, the carbon nanotubes 4 were grown on the surface of the positive electrode collector P1 so as to be oriented perpendicularly and so as to have a length of 800 μm at an operation pressure of 1 atmospheric pressure at a temperature of 750° C. in a growing time of 10 minutes. Granular sulfur was placed on the carbon nanotubes 4. The resulting carbon nanotubes 4 were mounted in a tubular furnace, and were covered with the sulfur 5 by heating the carbon nanotubes 4 to 120° C. for five minutes in an Ar atmosphere. The positive electrode P was thereby manufactured. In the positive electrode P, the weight of the sulfur 5 (impregnation amount) per unit area of the carbon nanotubes 4 was 4 mg/cm². As the negative electrode N, an electrode having a diameter of 15 mmφ and a thickness of 0.6 mm and made of metal lithium was used. As the separator S, a polypropylene porous film was used. The positive electrode P and the negative electrode N were disposed so as to face each other through the separator S. The polypropylene nonwoven fabric F including a sulfonic group was disposed between the separator S and the negative electrode N. The separator S was made to hold the electrolytic solution L. A coin cell of a lithium-sulfur secondary battery was thereby formed. Here, as the electrolytic solution L, a solution obtained by dissolving LiTFSI as an electrolyte in a mixed liquid (mixing ratio 9:1) of diethoxy ethane (DEE) and dioxolane (DOL), adjusting the concentration to 1 mol/l, and adding 1% lithium nitrate thereto, was used. The coin cell manufactured in this way was referred to as an invention product. A coin cell manufactured similarly to the above invention product except that a polypropylene nonwoven fabric including no sulfonic group was disposed in place of the polypropylene nonwoven fabric F including a sulfonic group, was referred to as comparative product 1. A coin cell manufactured similarly to the above invention product except that the nonwoven fabric F was not disposed, was referred to as comparative product 2. Discharge capacity retention rates (the discharge capacity at the second cycle was assumed to be 100%) obtained when charge-discharge measurement was performed for the invention product and comparative products 1 and 2 at a discharge current density of 0.5 mA/cm² are respectively illustrated in FIG. 3. It has been thereby confirmed that the invention product can suppress lowering of the charge-discharge capacity more than comparative products 1 and 2. It is considered that this is because the polypropylene nonwoven fabric F including a sulfonic group can suppress diffusion of a polysulfide into a negative electrode side. On the other hand, it has been confirmed that comparative product 1 has a lager amount of lowering in the charge-discharge capacity than comparative product 2. It is considered that this is because the conductivity of a lithium ion is reduced by disposition of a polypropylene nonwoven fabric including no sulfonic group.

Hereinabove, the embodiment of this invention has been described. However, this invention is not limited to those described above. The shape of the lithium-sulfur secondary battery is not particularly limited, and may be a button type, a sheet type, a laminate type, a cylinder type, or the like in addition to the above coin cell. In the above embodiment, a case where the nonwoven fabric F is disposed between the separator S and the negative electrode N has been exemplified. However, a nonwoven fabric may be disposed between the separator S and the positive electrode P. For example, when the amount of sulfur eluted into the electrolytic solution is large, a nonwoven fabric can be disposed both between the separator S and the positive electrode P and between the separator S and the negative electrode N.

### EXPLANATION OF REFERENCE MARKS

B lithium-sulfur secondary battery

P positive electrode N negative electrode

L electrolytic solution

P1 collector

1 substrate

4 carbon nanotube

5 sulfur

1. A lithium-sulfur secondary battery comprising:
a positive electrode including a positive electrode active material containing sulfur;
a negative electrode including a negative electrode active material containing lithium; and
a separator disposed between the positive electrode and the negative electrode to hold an electrolytic solution,
characterized in that a polymer nonwoven fabric containing a sulfonic group is disposed at least one of between the separator and the positive electrode and between the separator and the negative electrode.

2. The lithium-sulfur secondary battery according to claim 1, wherein
the positive electrode includes a collector and a plurality of carbon nanotubes oriented on a surface of the collector in a direction perpendicular to the surface, and
a surface of each of the carbon nanotubes is covered with sulfur such that a predetermined gap is present between the respectively adjacent carbon nanotubes.

3. The lithium-sulfur secondary battery according to claim 2, wherein each of the carbon nanotubes has a length of 100 to 1000 μm and a diameter of 5 to 50 nm.

4. The lithium-sulfur secondary battery according to claim 3, wherein the weight of sulfur which covers the surface of the carbon nanotubes is set to a value 0.7 to 3 times the weight of the carbon nanotubes.

5. The lithium-sulfur secondary battery according to claim 4, wherein the sulfur covering the surface of the carbon nanotubes has a thickness of 1 to 3 nm.
